(19) United States
(12) Patent Application Publication
(10) Pub. No.: US 2004/0006715 A1
(43) Pub. Date: Jan. 8, 2004

(54) System and method for providing security to a remote computer over a network browser interface

(76) Inventor: Nicholas C. Skrepetos, Eugene, OR (US)

Correspondence Address: MERCHANT & GOULD PC, P.O. BOX 2903, MINNEAPOLIS, MN, 55402-0903, US

(21) Appl. No.: 10/615,085

(22) Filed: Jul. 7, 2003

Related U.S. Application Data
(60) Provisional application No. 60/394,208, filed on Jul. 5, 2002.

(51) Int. Cl. H04L 9/00

(52) U.S. Cl. 713/201

(57) ABSTRACT

A system and method that securely eliminates traces of activity, scans for monitoring applications, clears user activities, and otherwise provides security to a remote computer. The system and method provides the functionality through a network browser without the need to install software on the remote computer.

### RELATED APPLICATIONS

This application claims the benefit of U.S. Provisional Application No. 60/394,208 filed Jul. 5, 2002, which is hereby claimed under 35 U.S.C. §119(e).

### FIELD OF THE INVENTION

The present invention relates to providing security to a remote computer. More particularly, the present invention is related to providing security to a remote computer over a network browser interface without installing software on the remote computer.

### BACKGROUND OF THE INVENTION

While performing tasks on a computer, the operating system and applications utilized usually leave a history trail of activity performed on the computer. These history trails may include items such as browser history, recently viewed documents, and non-obvious information such as browser cookies and cache information. These history trails often contain passwords and other sensitive data that may not be desirable to have another party view or access. In addition, applications that monitor the keystrokes, screens and other activity may be installed on the computer as well. These applications can record the activity for later viewing, or send the activity to an outside party or central server. These applications are often referred to as “spyware” and “snoopware” applications.

### SUMMARY OF THE INVENTION

The invention is directed at providing security to a remote computer over a network browser interface without the need to install software in the traditional manner on the remote computer. The invention provides a user the ability to solicit an application on a server over a network browser interface to scan a remote system for monitoring applications and securely eliminate traces of activity while avoiding installing software on the remote system. In one embodiment, the present invention allows a user to access the scanning and secure elimination of data though a network browser from any location that is connected to the network. The user is not required to install software on the computer to accomplish these tasks.

In another embodiment, the present invention maintains a database of the descriptions of the monitoring applications that includes the name and executable image of the file. Additional information such as file content, a digital “finger print”, file dates, sizes and registry keys, is also stored in the database. The database tracks new monitoring applications, which are produced and modified often. The central database allows rapid deployment of the descriptions of the monitoring applications. The present invention allows assessment and optional correction of the security of the computer in relation to whether the computer is being monitored or is monitoring a user's specific activity. In addition, the ability to remove the traces of activity is provided so that fragments of information are not left for another party to view and utilize at a later time. When data is removed from a remote computer using standard methods, the data still remains on the storage medium, such as a hard drive, and may be recovered by readily available tools and utilities at a later time. Accordingly, the methods for removing data provided by the present invention provide for removal of the data such that the data is not readily recoverable by other utilities, tools, users, or the like.

### BRIEF DESCRIPTION OF THE DRAWINGS

FIG. 1 illustrates an exemplary remote security architecture in accordance with the present invention.

FIG. 2 illustrates an exemplary logic flow diagram for a remote security process in accordance with the present invention.

FIG. 3 illustrates an exemplary logic flow diagram for a secure erasing process in accordance with the present invention.

FIG. 4 illustrates an exemplary logic flow diagram for a security scanning process in accordance with the present invention.

### DETAILED DESCRIPTION OF THE PREFERRED EMBODIMENT

In the following detailed description of exemplary embodiments of the invention, reference is made to the accompanied drawings, which form a part hereof, and which is shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

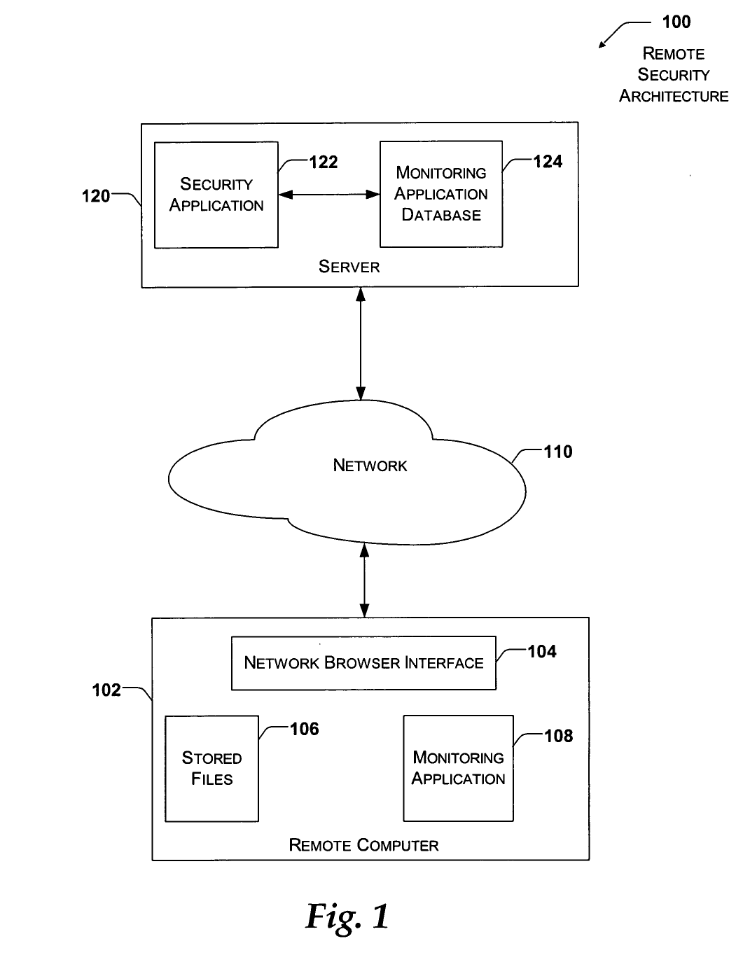

FIG. 1 illustrates an exemplary remote security architecture (100) in accordance with the present invention. Remote security architecture 100 includes a remote computer 102, network 110, and server 120. Remote computer 102 includes network browser interface 104 and may include stored files 106 and monitoring application 108. Server 120 includes security application 122 and monitoring application database 124.

Remote computer 102 may comprise a computing device such as a desktop computer, a laptop computer, a personal data assistant (PDA), a tablet computer, a cellular phone, a pocket PC, or the like. The variety of computing devices as well as their general operation are well known in the art and are not described in detail within this detailed description.

Monitoring application 208 may include software applications known as “snoopware”, “spyware”, or “adware”, which generally refer to applications that covertly gather user information through the user's Internet connection without his or her knowledge, usually for advertising purposes. Monitoring applications are typically bundled as a hidden component of freeware or shareware programs that can be downloaded from the Internet or other network. Once installed, the application monitors user activity on the Internet and transmits that information in the background to someone else. Monitoring applications can also gather information about e-mail addresses and even passwords and credit card numbers. Also, since monitoring applications often exist as independent executable programs, they have the ability to monitor keystrokes, scan files on the hard drive, snoop other applications, such as chat programs or word processors, install other monitoring programs, read cookies, change the default home page on the network browser, consistently relaying this information back to the application author who will either use it for advertising/marketing purposes or sell the information to another party.

Network 110 may comprise a network such the World Wide Web (WWW) or other network interface. The network may use any available transmission protocol such as TCP/IP or the like without departing from the spirit and scope of the present invention. The variety of networks and their transmission methods are also well known in the art and are not described in detail within this detailed description.

Security application 122 includes the functionality for providing the security option to a user of a remote computer (e.g., 102). In one embodiment, security application 122 operates by providing a user the ability to visit a web site using a network browser interface (e.g., 104) from any networked location or remote computer (e.g., 102) and optionally enter a login and password to access the scanning and cleaning services provided by security application 122. The login may be required to protect specific user information that may be stored, such as scanning and use history and settings specific to a user's computer and use of the system. An advantage of using a web site to represent the system is that the software is maintained up to date, avoiding the need to check for updates or download enhancements associated with downloaded software. However, in other embodiments, interface methods other than a web site may be used without departing from the spirit and scope of the present invention.

In one embodiment, the system uses MICROSOFT® ActiveX controls to encapsulate the code and perform the cleaning, scanning and secure erasing tasks. These modules are downloaded and installed by the browser when required for use.

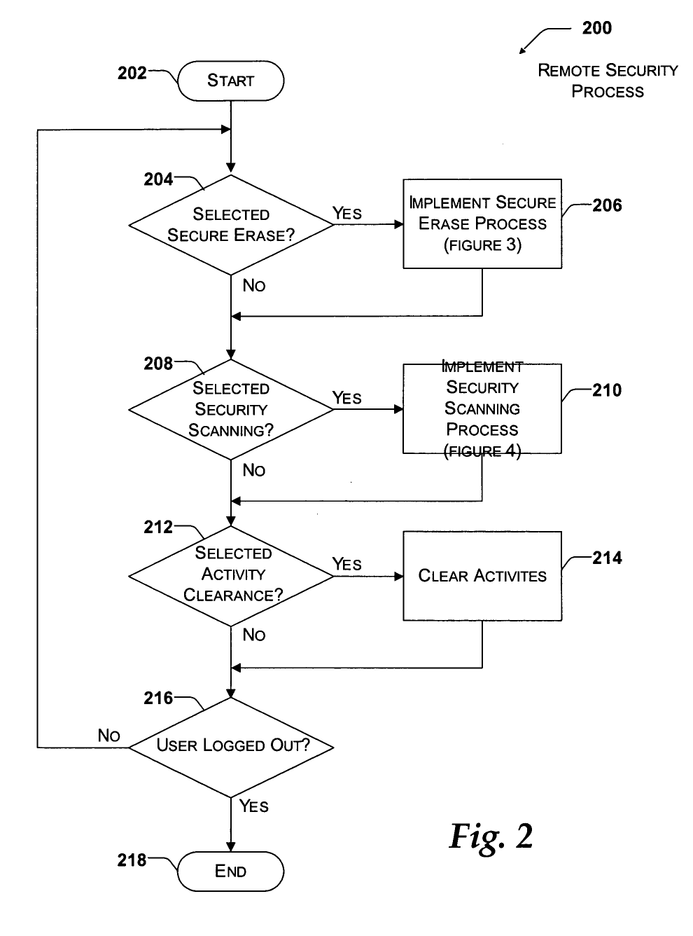

FIG. 2 illustrates an exemplary logic flow diagram for a remote security process (200) in accordance with the present invention. Process 200 begins at start block 202 where a user has navigated to a web site provided by the remote security system and entered any required user login information and passwords. Accordingly, the user is presented with options under the remote security process for securely erasing data, scanning for monitoring applications or other potentially threatening applications, and clearing user activities or specific files and folders from a remote computer. The process continues at decision block 204.

At decision block 204, a determination is made whether the user has selected the option for securely erasing data from the remote computer. If the option for securely erasing the data is not selected, processing advances to decision block 208. Alternatively, if the option for securely erasing the data is selected, processing proceeds to block 206.

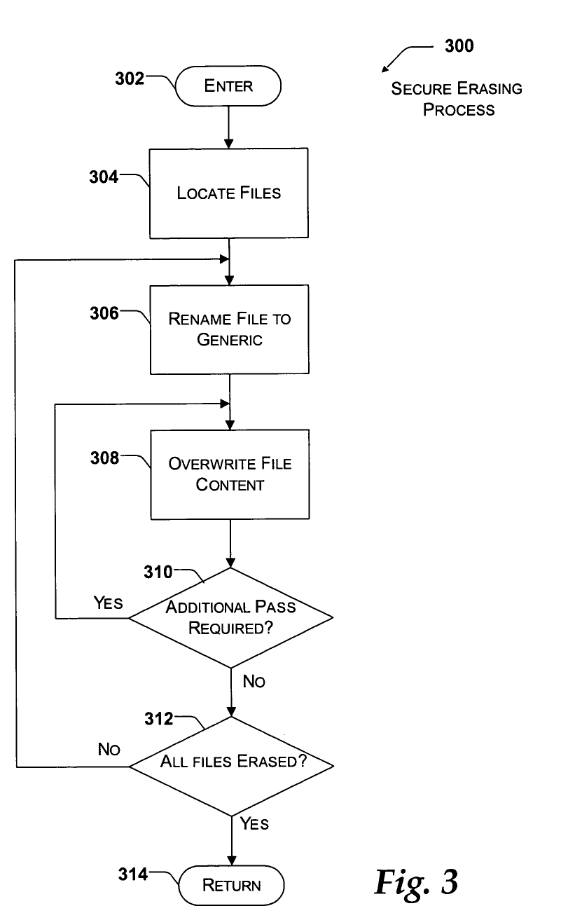

At block 206, a secure erase process is implemented. An illustrative secure erase process is further described in the discussion of FIG. 3 below. Once the secure erase process is implemented, processing proceeds to decision block 208.

At decision block 208, a determination is made whether the user has selected the option for scanning for monitoring applications present on the remote computer. If the option for scanning for monitoring applications is not selected, processing advances to decision block 212. Alternatively, if the option for scanning for monitoring applications is selected, processing proceeds to block 210.

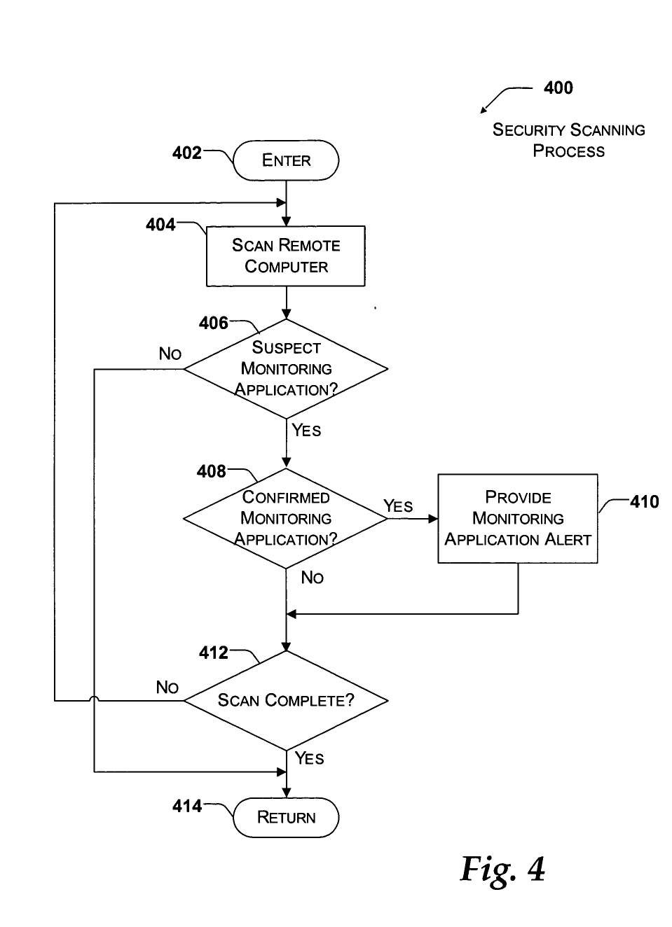

At block 210, a process for scanning for monitoring applications is implemented. An illustrative security scanning process that scans for monitoring applications on the remote computer is further described in the discussion of FIG. 4 below. Once the security scanning process is implemented, processing proceeds to decision block 212.

At decision block 212, a determination is made whether the user has selected the option for clearing the user's activities on the remote computer. If the option for clearing activities is not selected, processing advances to decision block 216. Alternatively, if the option for scanning for clearing activities is selected, processing proceeds to block 214.

At block 214, the activities of the user on the remote computer are cleared from the remote computer's memory. In one embodiment, the user selects which history and activity item to be cleared from the remote computer. In another embodiment, the security application automatically clears the history and activity items when the option for clearing the user's activities is selected, or a session for implementing the security options is complete. The activities are cleared such that they are substantially undeterminable by another utility, application, user, or the like. Stated differently, the activities are cleared such that a user attempting to discover the activities of the user is unable to do so by reasonable means. Once all of the selected activities have been cleared, processing proceeds to decision block 216.

At decision block 216, a determination is made whether the user has logged out of the session for implementing the security options. If the user has not logged out, then processing returns to block 204 where the options for providing security on the remote computer are available for selection. However, if the user has logged out, the session for implementing the security options is complete, and processing proceeds to block 218 where process 200 ends.

In a further embodiment, each option described in process 200 is automatically activated when the user enters in their login information. In one example, the remote computer is scanned for monitoring applications, certain files pre-selected by the user and stored in a user profile are automatically securely removed from the remote computer, and the activities of the user on the remote computer are cleared by accessing the security application through the network browser interface.

In still a further embodiment, in addition to process 200, the user may select browser cookies to save on the server so that login and password information is retained from web sites and domains selected by the user. Accordingly, a user profile may be generated for the user that is associated with the security application.

In yet another embodiment, further security options may be added to process 200 to enhance the security application's ability to provide security on a remote computer while avoiding installing software on the remote computer.

FIG. 3 illustrates an exemplary logic flow diagram for a secure erasing process (300) in accordance with the present invention. Process 300 enters at block 302 when process 200 shown in FIG. 2 enters block 206. Process 300 continues at block 304.

At block 304, the files to be securely deleted are located on the remote computer. In one embodiment, the user is prompted upon entering this process to select the files to be securely deleted. In another embodiment, the user generates a user profile that is stored on the server. The user profile has a pre-selected set of files to be securely deleted, and the security application then locates these files. In yet another embodiment, the files to be securely deleted are selected by the security application. The security application may select the files to be securely deleted according to a set of parameters previously entered by the user, such as a security level setting (e.g., medium security). Securely erasing a file is just one example in accordance with the present invention. In further embodiments, the present invention allows the user to “drag and drop” files and folders to a secure “recycle bin” located on a web page and have the items securely erased, and the present invention may selectively and securely erases items such as, but not limited to, browser drop-down URL history, browser history, browser cache, browser cookies, recently viewed documents, temporary files, downloaded program files, clipboard, recycle bin, auto-complete forms and password information, find history, run history and the like. Once the files or items to be securely deleted are located on the remote computer, processing continues at block 306.

At block 306, one of the files selected to be securely deleted is renamed to a generic name. For example, the file may be renamed to a generic name such as “aaaaaaaa.aaa”, or the like. In another embodiment, all located files may be renamed simultaneously. The renaming of the file assists in eliminating traces of the erased files remaining on the remote computer such that information of the possible contents of the file is substantially unrecoverable. Once the file is renamed, processing proceeds to block 308.

At block 308, the file(s) renamed to a generic name are overwritten with a selected sequence of data. In one example, the sequence consists of a sequence of zeros, a sequence of ones and then a random sequence of data. Other sequences of data are possible. Overwriting the location of the file with random data ensures that traces of the file content at that location are generally unrecoverable. Once the content of the file is overwritten, processing continues at decision block 310.

At decision block 310, a determination is made whether an additional pass of overwriting the content of the file is necessary. In one embodiment, additional passes at overwriting the data is an option that is selectable by the user. Multiple passes of overwriting the data at a location on the remote computer increases the likelihood that the original data is unrecoverable by other utilities, applications, or users. If an additional pass at overwriting the data is necessary, processing returns to block 308 where the file content is overwritten again. In a further embodiment, the present invention overwrites the actual data that describes the file system structure where the erased files resided to further prevent the discovery of any traces of the files existence. If however, an additional pass is not necessary, processing proceeds to decision block 312.

At decision block 312, a determination is made whether all files selected to be securely erased have been securely erased. If all selected files have not been securely erased, process 300 returns to block 306 where the process continues for any remaining selected files. However, if all selected files have been securely erased, processing proceeds to block 314 where process 300 returns to decision block 208 of process 200 shown in FIG. 2.

In a further embodiment, the system also provides a “secure” recycle bin and method in which to select files on the computer and have them securely erased. The selection occurs by the user selecting individual files or folders from the computer via a button on the web page, or by “dragging and dropping” a single or list of files onto the secure recycle bin location on the web page. Accordingly, the “slack” or remaining space on the storage medium may also be optionally securely overwritten to ensure that any data not in use by the system is removed.

FIG. 4 illustrates an exemplary logic flow diagram for a security scanning process (400) in accordance with the present invention. Process 400 enters at block 402 when process 200 shown in FIG. 2 enters block 210. Process 400 continues at block 404.

At block 404, the remote computer is scanned for any application that may be suspected to be a monitoring application or “spyware.” Each application on the remote computer is examined according to a set of known parameters for existing monitoring applications. As the remote computer is scanned, processing continues at decision block 406.

At decision block 406, a determination is made whether an application encountered during the scan of the remote computer is a suspect monitoring application. In one embodiment, an application is a suspect monitoring application when it meets one or more of the parameters for known existing monitoring applications. In one embodiment, the suspected monitoring applications are located whether they are currently in use on the computer or not. If no suspected monitoring applications are found during the scan of the remote computer, processing advances to block 414 where the process returns to decision block 212 of process 200 shown in FIG. 2. However, if a suspected monitoring application is found during the scan of the remote computer, processing proceeds to decision block 408.

At decision block 408, the suspect monitoring application is compared against a database containing descriptions of known monitoring applications to confirm whether the suspect monitor application matches a known monitoring application. The known monitoring application database is stored on the server. In one embodiment, descriptions of the known monitoring applications are updated and are available to the user when the user enters their login information. The system also provides descriptions of “suspicious” applications by using information stored in the database that describes patterns of operation of typical monitoring applications. In another embodiment, the user is also provided the ability to review the database of the known monitoring applications and items that the system currently detects. If the user does not find a particular application present, or determines that a monitoring application is in use on a particular computer that is not listed in the database, the user may elect to report the monitor's application to the server for possible inclusion. The reporting system sends a list of all processes running on the computer, as well as any other information for location and determination of a potential monitoring application. If the suspect monitoring application is not a monitoring application, processing advances to decision block 412. However, if the suspect monitoring application is confirmed to be a monitoring application, processing proceeds to block 410.

At block 410, the user is provided with a monitoring application alert to warn the user of the presence of a monitoring application on the remote computer and the possible option to remove the application. In one embodiment, a detailed description of the application, and its current “threat” to the user is displayed. The “threat” refers to what types of activities the monitoring application is capable of recording, monitoring, or receiving. Additional detailed information such as removal or bypassing instructions, if available, may also be displayed to the user. In a further embodiment, the system also optionally removes or disables applications, and components or parts of applications, that are used in the tracking and/or monitoring of a user's activity. For example, when the user is presented with the monitoring application alert, the user may also be prompted on whether the application should be removed. Prompting the user prior to removal of the application assists in avoiding removal of wanted applications. If the user selects to have the application removed when prompted, the present invention initiates an uninstall process for the discovered monitoring application. Processing then proceeds to decision block 412.

At decision block 412, a determination is made whether the scan of the remote computer is complete. If the scan of the remote computer is not complete, processing returns to block 404 where the scan of the remote computer continues. However, if the scan of the remote computer is complete, processing advances to block 414. At block 414, process 400 returns to decision block 212 of process 200 shown in FIG. 2.

The above specification, examples and data provide a complete description of the manufacture, use, and composition of the invention. Since many embodiments of the invention can be made without departing from the spirit and scope of the invention, the invention resides in the claims hereinafter appended.

I claim:

1. A computer-implemented method for providing security to a remote computer over a network browser interface, comprising:
selectively securely erasing a file associated with the remote computer, such that data associated with the file is substantially unrecoverable;
selectively scanning the remote computer to determine whether a monitoring application is present on the remote computer; and
selectively clearing activities of a user of the remote computer, such that the activities are substantially undeterminable, wherein downloading software onto the remote computer is avoided.

2. The computer-implemented method of claim 1, wherein the steps of selectively securely erasing the file, selectively scanning the remote computer, and selectively clearing activities of the user are selected to occur according to a selection made by the user.

3. The computer-implemented method of claim 1, wherein the steps of selectively securely erasing the file, selectively scanning the remote computer, and selectively clearing activities of the user are selected to occur by a security application in accordance with a user profile.

4. The computer-implemented method of claim 1, wherein selectively securely erasing the file further comprises renaming the file to a generic file name.

5. The computer-implemented method of claim 1, wherein selectively securely erasing the file further comprises overwriting data associated with the file with a sequence of data.

6. The computer-implemented method of claim 5, wherein selectively securely erasing the file further comprises determining whether additional passes of overwriting the data associated with the file are necessary after the data associated with the file is overwritten with the sequence of data.

7. The computer-implemented method of claim 1, wherein selectively securely erasing the file further comprises providing the user functionality for dragging and dropping a file into a secure recycle bin.

8. The computer-implemented method of claim 1, wherein selectively scanning the remote computer further comprises determining whether an application associated with the remote computer is a suspect monitoring application.

9. The computer-implemented method of claim 1, wherein selectively scanning the remote computer further comprises comparing an application associated with the remote computer to a database containing descriptions of known monitoring applications.

10. The computer-implemented method of claim 1, wherein selectively scanning the remote computer further comprises alerting the user to the presence of a monitoring application when a monitoring application is found on the remote computer.

11. The computer-implemented method of claim 1, wherein selectively scanning the remote computer further comprises transmitting information about a suspect monitoring application to a server across a network when a determination is made that the suspect monitoring application is a monitoring application that is previously unidentified.

12. The computer-implemented method of claim 1, wherein selectively scanning the remote computer further comprises removing monitoring applications discovered to be present on the remote computer.

13. The computer-implemented method of claim 1, wherein selectively scanning the remote computer further comprises removing monitoring applications discovered on the remote computer.

14. A computer-readable medium encoded with computer-executable instructions for performing a method comprising:
providing a web site by which a user of the remote computer accesses a security application associated with a server, wherein the security application provides security to a remote computer over a network browser interface;
securely erasing a file associated with the remote computer when a secure erasing option that is associated with the security application is selected, such that data associated with the file is substantially unrecoverable;
scanning the remote computer to determine whether a monitoring application is present on the remote computer when a security scanning option that is associated with the security application is selected; and
clearing activities of the user of the remote computer when an activity clearing option that is associated with the security application is selected, such that the activities are substantially undeterminable by another utility, wherein downloading software onto the remote computer is avoided.

15. The computer-readable medium of claim 14, wherein securely erasing the file further comprises renaming the file to a generic file name and overwriting data associated with the file with a sequence of data.

16. The computer-readable medium of claim 14, wherein securely erasing the file further comprises providing the user functionality for dragging and dropping a file into a secure recycle bin.

17. The computer-readable medium of claim 14, wherein scanning the remote computer further comprises:
alerting the user to the presence of a monitoring application when a monitoring application is found on the remote computer;
transmitting information about a suspect monitoring application to a server across a network when a determination is made that the suspect monitoring application is a monitoring application that is previously unidentified; and
removing monitoring applications discovered to be present on the remote computer.

18. A system for providing security to a remote computer over a network browser interface, comprising:
a web site by which a user of the remote computer accesses a security application;
a security application that includes instructions for performing a method comprising:
selectively securely erasing a file associated with the remote computer, such that data associated with the file is substantially unrecoverable;
selectively scanning the remote computer to determine whether a monitoring application is present on the remote computer; and
selectively clearing activities of the user of the remote computer, such that the activities are substantially undeterminable, wherein downloading software onto the remote computer is avoided.

19. The system of claim 18, wherein selectively securely erasing the file further comprises renaming the file to a generic file name and overwriting data associated with the file with a sequence of data.

20. The system of claim 18, wherein selectively scanning the remote computer further comprises:
alerting the user to the presence of a monitoring application when a monitoring application is found on the remote computer;
transmitting information about a suspect monitoring application to a server across a network when a determination is made that the suspect monitoring application is a monitoring application that is previously unidentified; and
removing monitoring applications discovered to be present on the remote computer.
